(19) United States
(12) Patent Application Publication
(10) Pub. No.: US 2004/0141190 A1
(43) Pub. Date: Jul. 22, 2004

(54) Printing apparatus, printing system, method of controlling the apparatus, and control program for executing the method

(76) Inventor: Masamichi Akashi, Chiba (JP)

Correspondence Address: ROSSI & ASSOCIATES, P.O. Box 826, Ashburn, VA, 20146-0826, US

(21) Appl. No.: 10/698,043

(22) Filed: Oct. 30, 2003

(30) Foreign Application Priority Data
Oct. 30, 2002 (JP) 2002-316470(PAT.

(51) Int. Cl. G06F 15/00

(52) U.S. Cl. 358/1.6; 358/1.13

(57) ABSTRACT

There is provided a printing apparatus which makes it possible to easily place restrictions upon servers that can be accessed, to thereby prevent improper print data from being printed or prevent access to servers in a manner incurring an increased communication cost. Data identification data for identifying data stored in a server on a network is input. Server identification data for identifying the server on the network is registered in an access restriction table, according to input from a user. The input data identification data is compared with the server identification data registered in the access restriction table to determine whether to acquire data from the server on the network.

### BACKGROUND OF THE INVENTION

1. Field of the Invention

The present invention relates to a printing apparatus having a reference printing function, a printing system, a method of controlling the printing apparatus, and a control program for executing the method.

2. Description of the Related Art

Conventionally, as a printing apparatus connected to a network, one has been known which has a so-called reference printing function of receiving an instruction indicative of the location of a server storing print data from a host computer, accessing the server at the indicated location, and receiving the print data stored in the server and printing the same.

It is impossible to restrict servers which can be accessed by this printing apparatus to only a server that stores print data, by e.g. permitting a user to access only a server storing proper print data. That is, the printing apparatus is allowed to access all types of servers on a network.

Therefore, a control method can be envisaged in which the printing apparatus is inhibited from accessing a server depending on the type thereof so that printing can be prevented from being performed based on improper print data such as destructive data. It is, however, difficult for the printing apparatus to automatically determine whether or not a server which the printing apparatus tries to access is an improper server storing destructive data.

Further, no restrictions are imposed upon the way of access to a server, and hence there is a possibility that the printing apparatus communicates with the server without permission in a manner incurring an increased access cost e.g. by using a telephone line in accessing the server.

Therefore, to prevent the printing apparatus from accessing an improper server or from accessing a server in a manner incurring an increased access cost to carry out reference printing, it is desirable to correctly designate a server which stores proper print data.

### SUMMARY OF THE INVENTION

It is an object of the present invention to provide a printing apparatus, a printing system, a method of controlling the printing apparatus, and a control program for executing the method, which make it possible to easily place restrictions upon servers that can be accessed, to thereby prevent improper print data from being printed or prevent access to servers in a manner incurring an increased communication cost.

To attain the above object, in a first aspect of the present invention, there is provided a printing apparatus that performs printing based on data acquired from a server on a network, comprising an input device that inputs data identification data for identifying data stored in the server on the network, a registration device that registers server identification data for identifying the server on the network, according to input from a user, and a determination device that compares the data identification data input by the input device with the server identification data registered by the registration deivce to determine whether to acquire data from the server on the network.

Preferably, server identification data identifying at least one server from which data is permitted to be acquired or server identification data identifying at least one server from which data is inhibited from being acquired is registered.

Also preferably, the printing apparatus according to the present invention comprises a device that specifies a protocol for access to the server, and the registration device registers the server identification data, and data indicating whether to permit access to the server by the protocol.

Preferably, the printing apparatus according to the present invention comprises a device that specifying a port for access to the server, and the registration device registers the server identification data, and data indicating whether to permit access to the server via a port number.

Preferably, the printing apparatus according to the present invention comprises an access control device that provides control to selectively permit or deny access to the server on the network according to a result of the determination made by the determination device.

To attain the above object, in a second aspect of the present invention, there is provided a printing system comprising a server located on a network, for storing print data, a host apparatus that transmits location data indicative of a location of the server on the network, and a printing apparatus that receives and prints the print data from the server according to the location data acquired from the host apparatus, and the printing apparatus comprises a decoding device that decodes data indicating whether access to at least one server on the network is to be permitted or not, and a determination device that determines whether to permit or deny access to the server according to the contents of the access restriction list.

To attain the above object, in a third aspect of the present invention, there is provided a method of controlling a printing apparatus having a location data acquiring device that acquires location data indicative of a location of a server located on a network and storing print data, and a reference printing function of receiving and printing the print data from the server according to the acquired location data, comprising the steps of decoding data indicating whether access to at least one server on the network is to be permitted or not, and selectively permitting or denying access of the printing apparatus to the server, corresponding to the location data acquired from the location data acquiring device, according to the contents of the access restriction list.

To attain the above object, in a fourth aspect of the present invention, there is provided a computer-readable control program for controlling a printing apparatus having a location data acquiring device that acquires location data indicative of a location of a server located on a network and storing print data, and a reference printing function of receiving and printing the print data from the server according to the acquired location data, comprising a decoding module for decoding data indicating whether access to the server on the network is to be permitted or not, and a connecting/disconnecting module for selectively permitting or denying access of the printing apparatus to the server, corresponding to the location data acquired from the location data acquiring device, according to the contents of the access restriction list.

As described above, according to the present invention, access to servers can be easily restricted by using an access restriction table, thereby preventing improper print data from being printed and easily realizing management of e.g. costs by an administrator.

The above and other objects, features, and advantages of the invention will become more apparent from the following detailed description taken in conjunction with the accompanying drawings.

### BRIEF DESCRIPTION OF THE DRAWINGS

FIG. 1 is a block diagram showing the arrangement of a printing system according to an embodiment of the present invention;

FIG. 2 is a flow chart showing the operation of the printing system in FIG. 1;

FIG. 3 is a view showing an example of an access restriction list used by the printing system in FIG. 1;

FIG. 4 is a flow chart showing in detail the FIG. 2 operation;

FIG. 5 is a view showing an example of an access restricting operation specified by default;

FIG. 6 is a view showing another example of the access restriction list used by the printing system;

FIG. 7 is a view showing still another example of the access restriction list used by the printing system; and

FIG. 8 is a sectional view showing the internal construction of a laser beam printer applied to a printing apparatus appearing in FIG. 1.

### DETAILED DESCRIPTION OF THE PREFERRED EMBODIMENTS

The present invention will now be described in detail with reference to the drawings showing a preferred embodiment thereof.

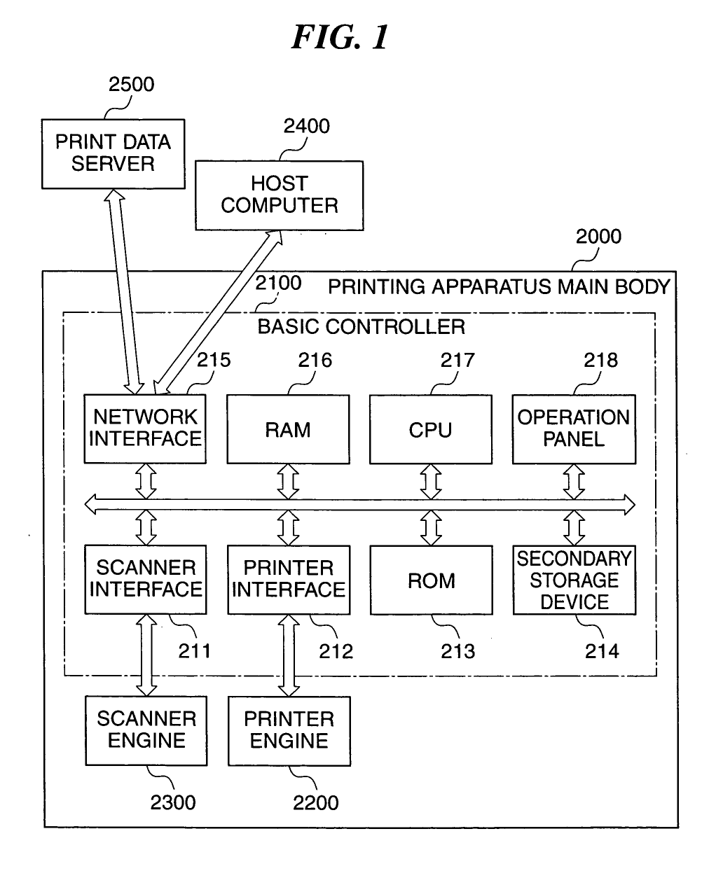

FIG. 1 is a block diagram showing the arrangement of a printing system according to an embodiment of the present invention.

The printing system according to the present embodiment is comprised mainly of five component parts: a basic controller 2100, a printer engine 2200, a scanner engine 2300, a host computer 2400, and a print data server 2500. The basic controller 2100, the printer engine 2200, and the scanner engine 2300 constitute the main body of a printing apparatus 2000.

In this printing system, the host computer 2400 transmits a network address of a server storing print data to be printed, i.e. information written as a ULR (Universal Resource Location), for example, to the basic controller 2100. The basic controller 2100 decodes the transmitted network address, accesses the print data server 2500, which stores the print data to be actually printed, according to the result of decoding, to receive the print data, and causes the printer engine 2200 to print the received print data.

A detailed description will now be given of the basic controller 2100. The basic controller 2100 is comprised of a CPU 217, a secondary storage device 214, a printer interface 212, a scanner interface 211, a ROM 213, a network interface 215, a RAM 216, and an operation panel 218.

For example, the CPU 217 controls the overall operation of the printing apparatus 2000, and provides control to read and write information from and into the secondary storage device 214, receive data from a network by packet communication, perform processing in accordance with a protocol, and temporarily store bitmap information. The printer interface 212 provides interface for sending and receiving data to and from the printer engine 2200. The scanner interface 211 provides interface for sending and receiving data to and from the scanner engine 2300.

The ROM 213 stores a program for activating the printing apparatus 2000, a main program for controlling the printing apparatus 2000, a variety of printer control languages, font information, and so forth. The RAM 216 is used for temporarily storing information; for example, the RAM 216 servers as a work area for information processing, an area for temporarily storing data supplied from the network interface 215, a buffer area for input and output to and from the secondary storage device 214, and so forth. The operation panel 218 is used for setting, changing, and displaying parameters relating to a printing environment according to e.g. settings inputted by the user.

The printing apparatus 2000 according to the present embodiment acquires a network address of the print data server 2500 storing print data, i.e. the address which is inputted to the host computer 2400 from an input device such as a keyboard (not shown), from the host computer 2400, decodes an access restriction list, described later, indicative of whether access is to be permitted or denied, and determines whether to permit or deny access to the print data server 250 according to the result of decoding the access restriction list. This operation will be described below in further detail.

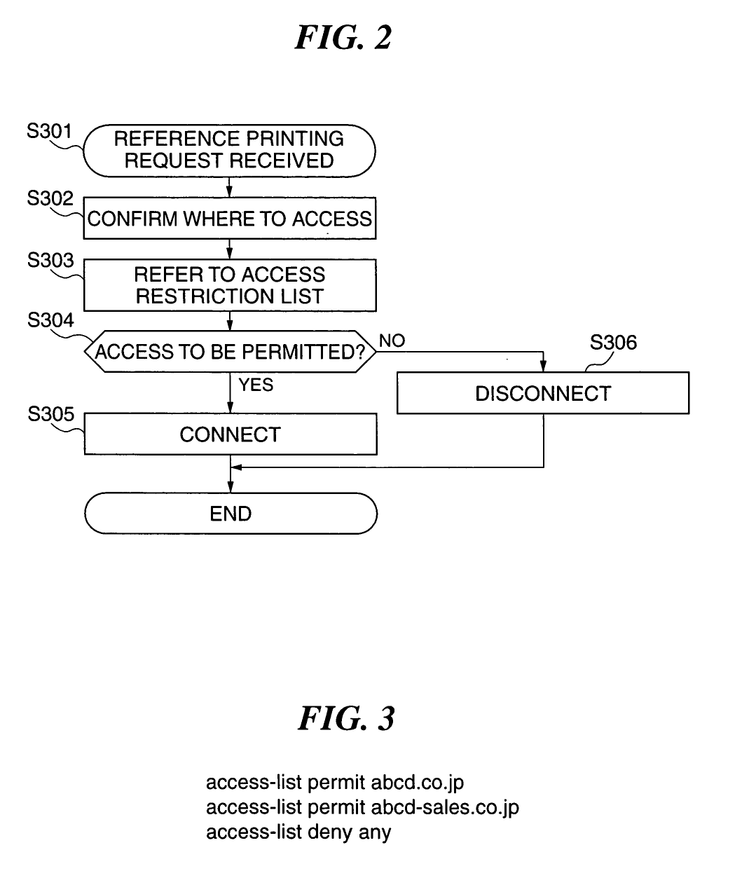

FIG. 2 is a flow chart showing the operation of the printing system in FIG. 1, i.e. a sequence of operations performed since the printing apparatus 2000 receives an access request from the host computer 2400 until it is determined whether access to the designated print data server 2500 is to be permitted or denied. This sequence of operations is performed in accordance with an access restriction list allocated to each print job. The access restriction list can be set through the operation of the operation panel 218 or the host computer 2400 by the user, or can be supplied from a file. It is assumed here that the access restriction list is set in advance before the sequence of operations in FIG. 2 is started. Specifically, as shown in FIG. 3, whether access to servers is permitted or not is written and registered in the access restriction list by listing, for example, a character string in which a character string “permit” is added as a first argument to a character string representing the network address of a server to which access is to be permitted, and a character string in which a character string “deny” is added as a first argument to a character string representing the network address of a server to which access is to be denied or a character string “any” representing the network address of any server other than servers to which access is to be permitted.

First, the network interface 215 receives a reference printing request including a network address of the print data server 2500 as an IP address and port, to which access is requested by the host computer 2400, from the host computer 2400 (step S301). According to the contents of the received reference printing request, the CPU 217 identifies where to access, i.e. a network address of the print data server 2500 as the IP address and port to which access is requested by the host computer 2400 (step S302).

Then, the CPU 217 refers to the set access restriction list (step S303), and determines whether access to the print data server 2500 to which access is requested is to be permitted or denied (step S304). If determining that access to the print data server 2500 is to be permitted, the CPU 217 immediately causes the printing apparatus 2000 to access the print data server 2500 (step S305), and if determining that access to the print data server 2500 is to be denied, the CPU 217 immediately inhibits the printing apparatus 2000 from accessing the print data server 2500 (step S306), followed by terminating the process.

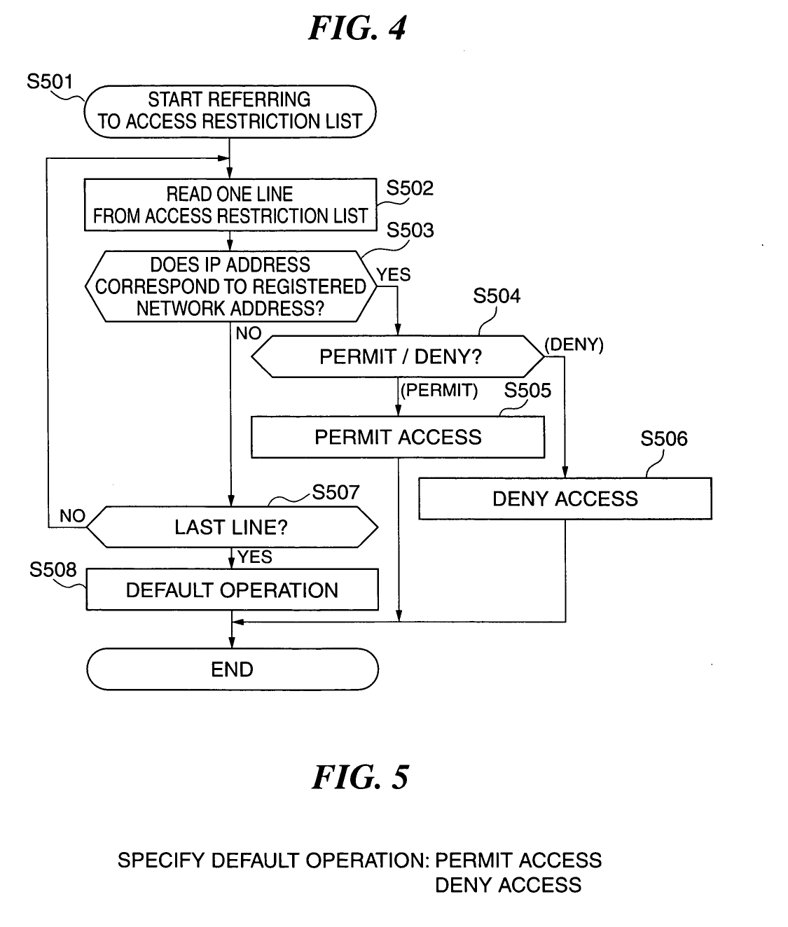

FIG. 4 is a flow chart showing in detail the FIG. 2 operation (access determining process). Referring to FIG. 4, a detailed description will now be given of a sequence of operations performed since the access restriction list is referred to (corresponding to the step S303) until it is determined whether access to the print data server 2500 is to be permitted or denied (corresponding to the step S304).

First, reference to the access restriction list is started (step S501), and one line is read from the access restriction list (step S502). Then, it is determined whether or not the IP address and port to which access is requested by the host computer 2400 corresponds to a network address on the read one line from the access restriction list (step S503).

If the determination result in the step S503 is positive (“YES” in the step S503), it is then determined whether the first argument on the read one line is “permit” or “deny” (step S504). If the first argument is “permit”, the printing apparatus 2000 is immediately caused to access the print data server 2500 corresponding to the network address on the read one line (step S505), followed by termination of the process. If the first argument is “deny”, access to the print data server 2500 corresponding to the network address on the read one line is denied (step S506), followed by termination of the process.

If the determination result in the step S503 is negative (“NO” in the step S503), it is then determined whether the read one line is the last line of the access restriction list or not (step S507). If the read one line is not the last line (“NO” in the step S507), the process returns to the step S502 to perform the processing from the steps S502 to S507 again. If the read one line is the last line (“YES” in the step S507), the access determining process using the access restriction list is terminated, and whether access to the print data server 2500 to which access is requested by the host computer 2400 is to be permitted or not is determined in accordance with an instruction indicative of an operation specified by default as shown in FIG. 5, followed by termination of the process.

It should be noted that the above described control method can be realized by storing a program according to the above described flow charts of FIGS. 2 and 4 in the ROM 213 of the printing apparatus 2000, and causing the CPU 217 to execute the stored program.

As described above, according to the present embodiment, access to servers can be easily restricted using the access restriction list, thereby preventing improper print data from being printed and enabling an administrator of the system to manage costs or the like.

It should be understood that the present invention is not limited to the embodiment described above, but various variations of the above described embodiment may be possible without departing from the spirits of the present invention, including variations as described below, for example.

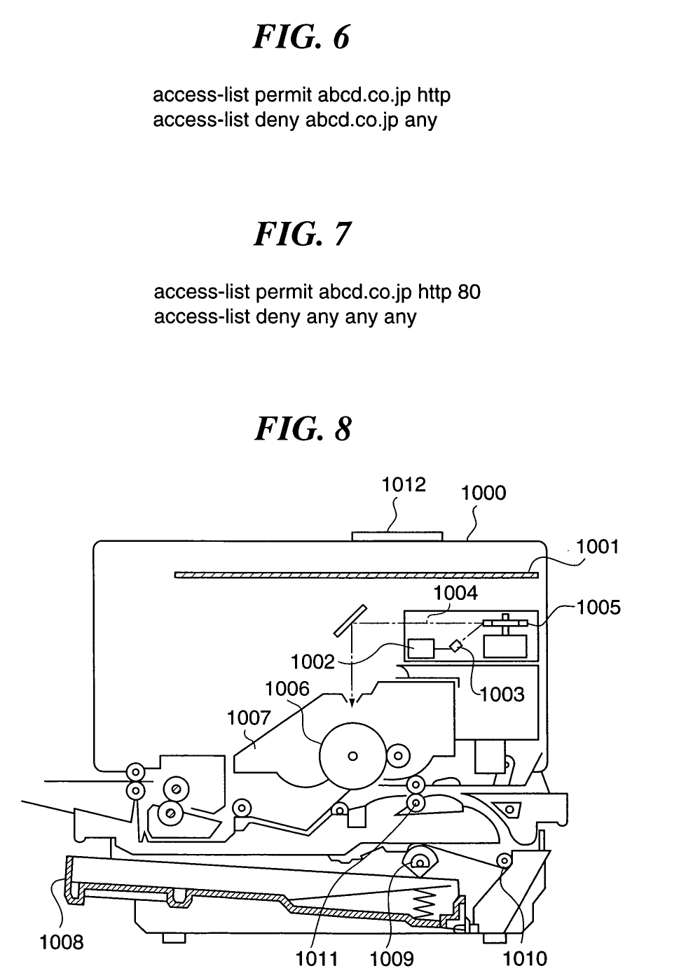

FIG. 6 shows an example of an access restriction list used in the case where access is restricted according to a protocol by the printing apparatus which is capable of specifying a protocol for access to the server 2500. In the example shown in FIG. 6, on the first line of the access restriction list, access to a domain “abcd.co.jp” by using “http” is permitted, and on the second line, access to the domain “abcd.co.jp” by using other protocols is denied.

FIG. 7 shows an example of an access restriction list used in the case where access is restricted according to a port number by the printing apparatus which is capable of designating a port for access to the server 2500. In the example shown in FIG. 7, on the first line of the access restriction list, access to a domain “abcd.co.jp” via a port No. 80 by using “http” is permitted, and on the second line, access to all domains via all ports by other protocols is denied.

Although in the above described embodiment, one port is designated, a range comprised of a plurality of ports may be designated.

Although in the above described embodiment, a logical port is assigned to an IP protocol on a network, the present invention can also be realized by assigning one logical port to another protocol.

Although in the above described embodiment, a logical port is assigned to a protocol on a network, the present invention can also be realized by assigning one logical port to an interface such as a Centronics or a serial interface, which is not a protocol on a network.

As described above, according to the above described embodiment and variations, a destination to be accessed can be designated for each protocol or each port by referring to the access restriction list, and hence servers to be accessed by the printing apparatus can be restricted, making it easier to manage the printing apparatus in terms of security and management.

FIG. 8 is a sectional view showing the internal construction of a laser beam printer (hereinafter abbreviated as “LBP”) applied as the printing apparatus according to the present embodiment.

The LBP is capable of registering character patterns, templates (form data), and so forth from a data source, not shown.

In FIG. 8, the LBP 1000 receives and stores character information (character code) and form information or a macro instruction from the host computer 2400 externally connected thereto, and prepares a corresponding character pattern, a form pattern, and so forth according to the information to form an image on a recording sheet as a storage medium.

On an operation panel 1012 are arranged switches and LED displays used for operation. A printer control unit 1001 controls the overall operation of the LBP 1000, and analyzes character information and the like supplied form the host computer 2400. The printer control unit 1001 mainly converts character information into a video signal indicative of the corresponding character pattern and outputs the signal to a laser driver 1002.

The laser driver 1002 is a circuit for driving a semiconductor laser 1003, and selectively turns on or off laser 1004 emitted from the semiconductor laser 1003 according to the input video signal. The laser 1004 is swung in the horizontal direction by a rotary polygon mirror 1005 to scan an electrostatic drum 1006. This forms an electrostatic latent image of the character pattern on the electrostatic drum 1006.

The electrostatic latent image is developed by a developing unit 1007 disposed around the electrostatic drum 1006 and then transferred onto a recording sheet. A cut sheet is used as the recording sheet. The cut sheet is stored in a sheet cassette 1008 attached to the LBP 1000, and is fed into the LBP 1000 by a sheet feed roller 1009 and conveying rollers 1010 and 1011 and then supplied to the electrostatic drum 1006.

Although in the above described embodiment the printing apparatus according to the present invention is applied to an LBP, the present invention may be applied to an ink jet printer based on another printing method. Also, the present invention may be applied to a copying machine and a multifunction printer (MFP).

Further, the present invention should not be limited to the apparatus according to the above described embodiment and variations, but may either be applied to a system composed of a plurality of apparatuses or to a single apparatus.

It goes without saying that the object of the present invention may also be accomplished by supplying a system or an apparatus with a storage medium in which a program code of software which realizes the functions of any of the above described embodiment and variations is stored, and causing a computer (or CPU or MPU) of the system or apparatus to read out and execute the program code stored in the storage medium.

In this case, the program code itself read from the storage medium realizes the functions of any of the above described embodiment and variations, and hence the program code and a storage medium on which the program code is stored constitute the present invention.

Examples of the storage medium for supplying the program code include a floppy disk (registered trademark), a hard disk, an optical disk, a magnetic-optical disk, a CD-ROM, a CD-R, a CD-RW, a DVD-ROM, a DVD-RAM, a DVD+RW, a magnetic tape, a nonvolatile memory card, and a download carried out via a network.

Further, it goes without saying that the functions of any of the above described embodiment and variations may be accomplished not only by executing the program code read out by a computer, but also by causing an OS (operating system) or the like which operates on the computer to perform a part or all of the actual operations based on instructions of the program code.

Further, it is to be understood that the functions of any of the above described embodiment and variations may be accomplished by writing the program code read out from the storage medium into a memory provided in an expansion board inserted into a computer or a memory provided in an expansion unit connected to the computer and then causing a CPU or the like provided in the expansion board or the expansion unit to perform a part or all of the actual operations based on instructions of the program code.

What is claimed is:

1. A printing apparatus that performs printing based on data acquired from a server on a network, comprising:
an input device that inputs data identification data for identifying data stored in the server on the network;
a registration device that registers server identification data for identifying the server on the network, according to input from a user; and
a determination device that compares the data identification data input by said input device with the server identification data registered by said registration device to determine whether to acquire data from the server on the network.

2. A printing apparatus according to claim 1, wherein server identification data identifying at least one server from which data is permitted to be acquired or server identification data identifying at least one server from which data is inhibited from being acquired is registered.

3. A printing apparatus according to claim 1, comprising a device that specifies a protocol for access to the server, and wherein said registration device registers the server identification data, and data indicating whether to permit access to the server by the protocol.

4. A printing apparatus according to claim 1, comprising a device that specifying a port for access to the server, and wherein said registration device registers the server identification data, and data indicating whether to permit access to the server via a port number.

5. A printing apparatus according to claim 1, comprising an access control device that provides control to selectively permit or deny access to the server on the network according to a result of the determination made by said determination device.

6. A printing system comprising:
a server located on a network, for storing print data;
a host apparatus that transmits location data indicative of a location of said server on the network; and
a printing apparatus that receives and prints the print data from said server according to the location data acquired from said host apparatus; and
wherein said printing apparatus comprises:
a decoding device that decodes data indicating whether access to at least one server on the network is to be permitted or not; and
a determination device that determines whether to permit or deny access to said server according to the contents of the access restriction list.

7. A method of controlling a printing apparatus having a location data acquiring device that acquires location data indicative of a location of a server located on a network and storing print data, and a reference printing function of receiving and printing the print data from the server according to the acquired location data, comprising the steps of:
decoding data indicating whether access to at least one server on the network is to be permitted or not; and
selectively permitting or denying access of the printing apparatus to the server, corresponding to the location data acquired from the location data acquiring device, according to the contents of the access restriction list.

8. A computer-readable control program for controlling a printing apparatus having a location data acquiring device that acquires location data indicative of a location of a server located on a network and storing print data, and a reference printing function of receiving and printing the print data from the server according to the acquired location data, comprising:
a decoding module for decoding data indicating whether access to the server on the network is to be permitted or not; and
a connecting/disconnecting module for selectively permitting or denying access of the printing apparatus to the server, corresponding to the location data acquired from the location data acquiring device, according to the contents of the access restriction list.
